(19) United States
(12) Patent Application Publication
(10) Pub. No.: US 2011/0130064 A1
(43) Pub. Date: Jun. 2, 2011

(54) METHOD FOR FABRICATING ALTERNATING-CURRENT LIGHT-EMITTING-DIODE PACKAGE DEVICE

(76) Inventor: CHUNG-LIN WANG, HSINCHU CITY 300 (TW)

(21) Appl. No.: 12/955,074

(22) Filed: Nov. 29, 2010

(30) Foreign Application Priority Data
Dec. 1, 2009 (TW) 098140960

(51) Int. Cl. H01J 9/00

(52) U.S. Cl. 445/23

(57) ABSTRACT

The present invention discloses a method for fabricating an AC LED package device, which comprises steps: providing a plurality of LED modular chips each having a plurality of LEDs in same polar direction in series; connecting forward and reversely the LED modular chips with a wire-bonding method to form an AC LED package device; and connecting the AC LED package device with an AC power source. In the present invention, the LED modular chips, each of which have LEDs all connected in same polar direction, are used to form an AC LED package device. Therefore, the present invention is using less-complicated photomasks compared with prior art. Accordingly, the present invention simplifies the process, promotes the yield and lowers the cost.

### BACKGROUND OF THE INVENTION

1. Field of the Invention

The present invention relaters to AC LED, particularly to a method combining SOC (system on chip) and SOB (system on board) technologies to fabricate an AC LED package device.

2. Description of the Related Art

LED (Light Emitting Diode) has advantages that the conventional light sources do not have, such as high efficiency, long service life, durability and low power consumption. Therefore, LED has been extensively used in various fields. LED is driven by direct current (DC). However, commercial power provides alternating current (AC). Therefore, alternating current of commercial power is transformed into direct current to drive LED by transformers or AC/DC converters.

As AC/DC converters are expensive, technologies were developed to directly use alternating current to drive LED, wherein LED dice that have the rectification characteristic of PN diodes are arranged in special ways, whereby alternating current can flow bidirectionally to drive the LED chips. Refer to FIG. 1 a diagram schematically showing a conventional anti-parallel-type AC LED modular chip. The AC LED modular chip comprises two LED strings, a forward LED string 10 and a reverse LED string 12. Each of the LED strings 10 and 12 has a plurality of LEDs 16. Each of the LED strings 10 and 12 has two ends respectively connecting with two terminals of an AC power source 14. Thus, the AC power source 14 can alternately drive the LED strings 10 and 12, which respectively have different conduction directions, to emit light.

In addition to the parallel-type AC LED modular chip, there is also a bridge-type AC LED modular chip. Refer to FIG. 2 a diagram schematically showing a conventional bridge-type AC LED modular chip. The bridge-type AC LED modular chip comprises five LED strings a first LED string 18, a second LED string 20, a third LED string 22, a fourth LED string 24 and a common LED string 26. Each of the LED strings 18, 20, 22, 24 and 26 has a plurality of LEDs. The first LED string 18 and the second LED string 20 are forward cascaded. The third LED string 22 and the fourth LED string 24 are forward cascaded. The first LED string 18 is reversely cascaded with the third LED string 20. The second LED string 22 is reversely cascaded with the fourth LED string 24. The common LED string 26 is forward cascaded with the first, second, third, and fourth LED strings 18, 20, 22 and 24. Thereby is formed a bridge-type AC LED modular chip. The two ends of the bridge-type AC LED modular chip are respectively connected with two terminals of an AC power source 28. The positive semi-cycle of the AC power source 28 flows along a first path P1 to drive the first LED string 18, the common LED string 26 and the fourth LED string 24 to emit light. The negative semi-cycle of the AC power source 28 flows along a second path P2 to drive the third LED string 22, the common LED string 26 and the second LED string 20 to emit light. The two groups of the four LED strings on the four sides of the bridge-type circuit respectively emit light alternately. The common LED string 26 emits light persistently.

In both the parallel-type and bridge-type AC LED modules, forward LED strings and reverse LED strings are used as the basic units, and the basic units are fabricated into a single chip, i.e. a system-on-chip (SOC), via a semiconductor process. However, more complicated photomasks are needed in fabricating both forward LED strings and reverse LED strings on a single chip simultaneously. Thus, such a technology has lower yield and higher cost. Further, manufacturers have to spend much money designing new photomasks for a new LED configuration.

Accordingly, the present invention proposes a method for fabricating an AC LED package device to solve the abovementioned problems.

### SUMMARY OF THE INVENTION

The primary objective of the present invention is to provide a method for fabricating an AC LED package device, which combines the SOC ad SOB technologies and has the advantages of them.

Another objective of the present invention is to provide a method for fabricating an AC LED package device, which is using less-complicated photomasks compared with prior art, whereby to promote yield and to reduce cost.

To achieve the abovementioned objectives, the present invention proposes a method for fabricating an AC LED package device, which comprises steps: providing a plurality of LED modular chips, which are fabricated on at least one wafer, wherein each LED modular chip has a plurality of LEDs in same polar direction connecting in series; respectively arranging at least two LED modular chips on a package substrate forward and reversely, and connecting the LED modular chips with a wire-bonding method to form an AC LED package device; connecting the AC LED package device with an AC power source to drive the AC LED package device to emit light.

Below, the embodiments are described in detail in cooperation with the attached drawings to make easily understood the objectives, technical contents, characteristics and accomplishments of the present invention.

### BRIEF DESCRIPTION OF THE DRAWINGS

FIG. 1 is a diagram schematically showing the structure of a conventional anti-parallel-type AC LED module;

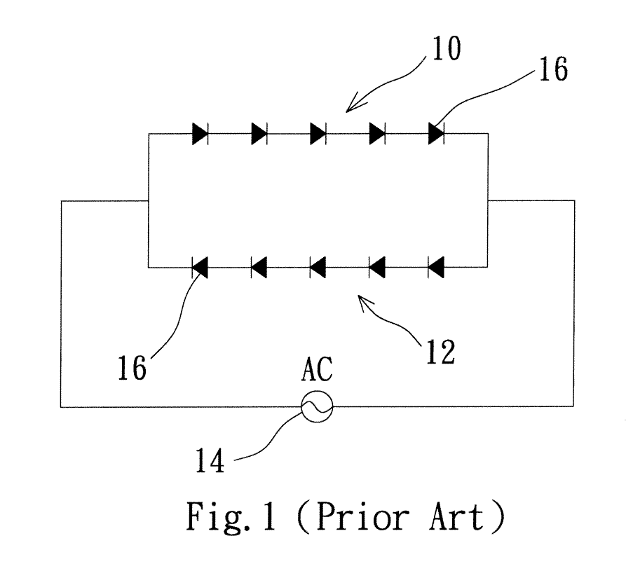

FIG. 2 is a diagram schematically showing a conventional bridge-type AC LED module;

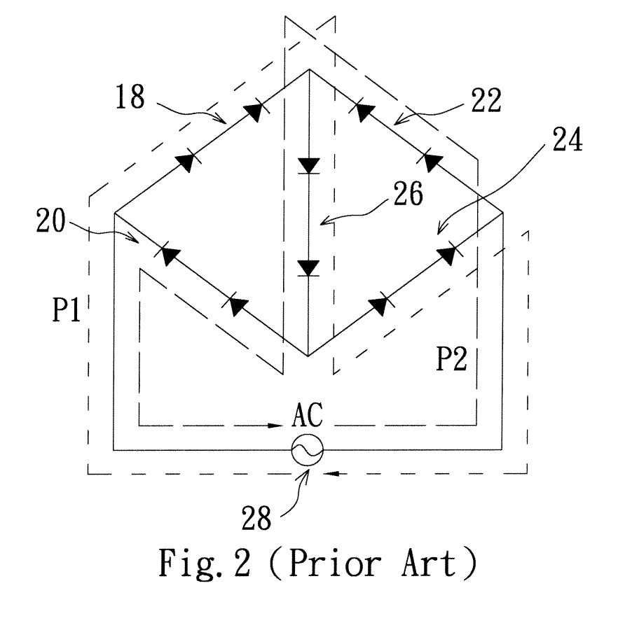

FIG. 3 is a flowchart of a method for fabricating an AC LED package device according to one embodiment of the present invention;

FIG. 4 is a diagram schematically showing that LED modular chips are fabricated on a wafer, wherein FIGS. 4(a)-(c) respectively schematically show the LED modular chips according to several embodiments of the present invention; and

FIG. 5 is a diagram schematically showing the structure of a anti-parallel-type AC LED package device according to one embodiment of the present invention; and

FIG. 6 is a diagram schematically showing the structure of a bridge-type AC LED package device according to one embodiment of the present invention.

### DETAILED DESCRIPTION OF THE INVENTION

In order to reduce complexity of process and photomasks, the method of the present invention adopts a SOC process in the front stage thereof and a SOB process in the rear stage thereof.

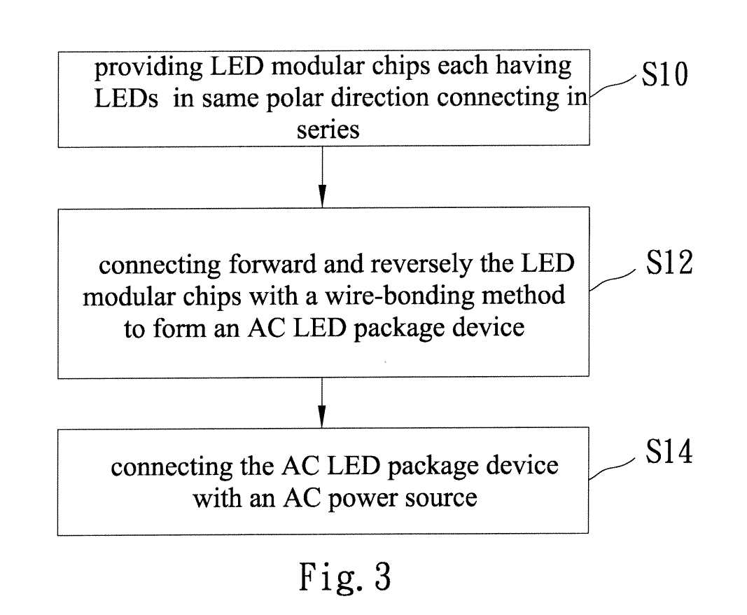

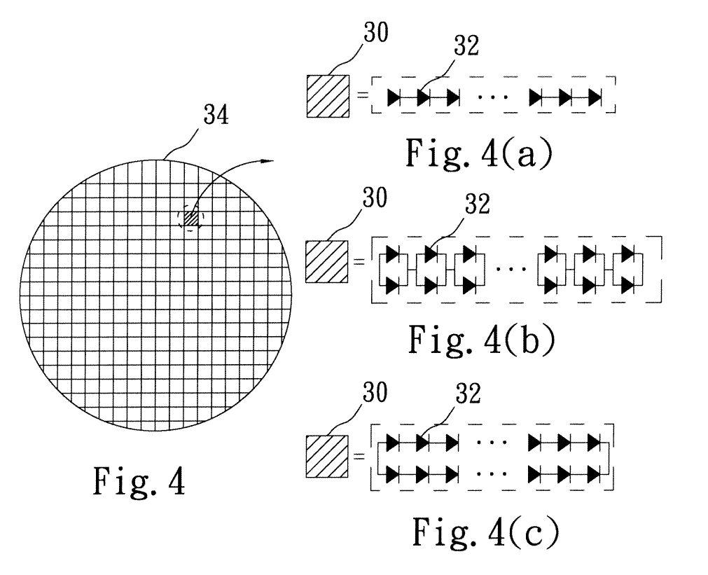

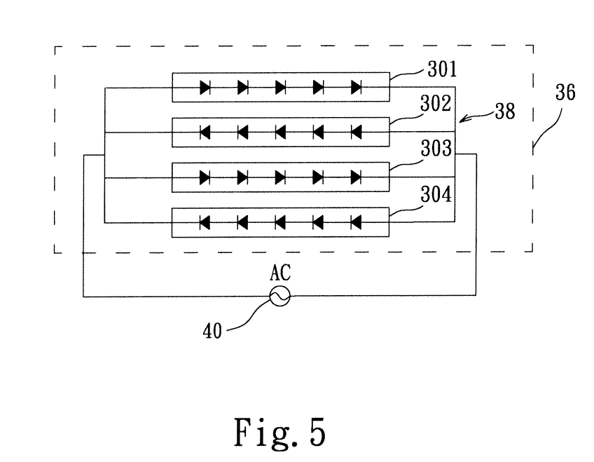

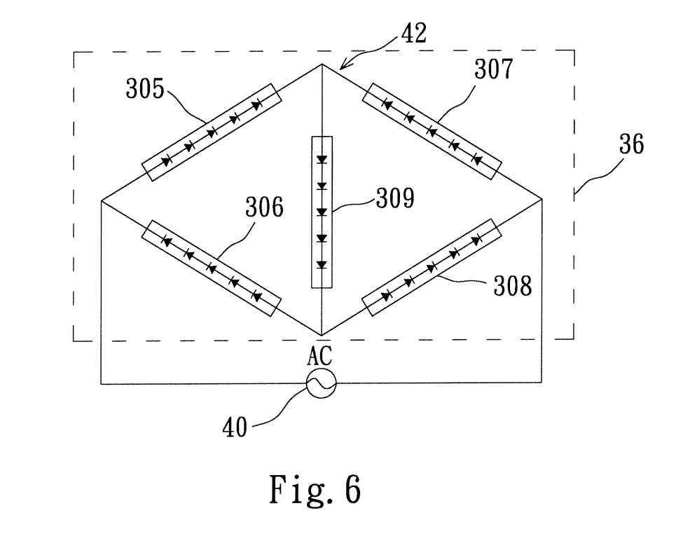

Refer to FIG. 3 and FIG. 4. FIG. 3 is a flowchart of a method for fabricating an AC LED package device according to one embodiment of the present invention. FIG. 4 is a diagram schematically showing that LED modular chips are fabricated on a wafer according to one embodiment of the present invention. In Step S10, provide a plurality of LED modular chips 30. Each LED modular chip 30 has a plurality of LEDs 32 connected in same polar direction. In the present invention, a LED modular chip 30 may have from two to dozens of LEDs 32. A LED modular chip 30 having five LEDs 32 will be used as the exemplification (in FIG. 5 and FIG. 6) below. The LED modular chip 30 have a string of cascaded LEDs 32 (as shown in FIG. 4(a)) or two or more strings of cascaded LEDs 32. Alternatively, the LEDs 32 are connected in parallel to form a plurality of parallel LED units, and the parallel LED units are connected in series to form the LED modular chip 30, as shown in FIG. 4(b). Alternatively, at least two strings of LEDs 32 connected in an identical polarity are connected in parallel to form the LED modular chip 30, as shown in FIG. 4(c). The LED modular chips 30 are directly fabricated on at least one wafer 34. The wafer 34 is a visible light-LED substrate or an invisible light-LED substrate, which is made of a material selected from a group consisting of gallium arsenide, silicon nitride, aluminum oxide, germanium, gallium phosphide, silicon, glass, and sapphire. As all the LEDs 32 of the LED modular chips 30 are fabricated on a wafer 34 in same polar direction, the present invention may adopt simpler photomasks to fabricate the LED modular chips 30. Therefore, the present invention can use less-complexity of the fabrication process compared with prior art. The abovementioned step belongs to the front-stage SOC process.

After the LED modular chips 30 are fabricated with the front-stage SOC process, the rear-stage SOB process is undertaken. In Step S12, at least two LED modular chips 30 are forward and reversely connected respectively and then connected in parallel, in series, or in parallel and series, via a wire-bonding method, to form an AC LED package device. The LED modular chips 30 on the AC LED package device may all have same number of LEDs 32 or respectively have different numbers of LEDs 32. Then, in Step S14, the AC LED package device is connected with an AC power source.

In Step S12 and Step S14, the LED modular chips may be arranged in various ways and then wire-bonded. Below, the parallel (arrayed)-type arrangement and the bridge-type arrangement are used as the exemplifications to describe the configurations of the AC LED package device.

Refer to FIG. 5 a diagram schematically showing the structure of a parallel-type AC LED package device according to one embodiment of the present invention. A least two LED modular chips each having LEDs connected in same polar direction are parallel arranged on a package substrate. In this embodiment, four LED modular chips are parallel arranged on a package substrate 36. A first LED modular chip 301 and a third LED modular chip 303 are forward arranged on the package substrate 36. A second LED modular chip 302 and a fourth LED modular chip 304 are reversely arranged on the package substrate 304. Thus is formed a parallel-type AC LED package device 38. Two ends of each of the LED modular chips 301, 302, 303 and 304 are connected with an AC power source 40. Thereby, the current of the AC power source 40 can flow bidirectionally to drive the LED modular chips to emit light.

Refer to FIG. 6 a diagram schematically showing the structure of a bridge-type AC LED package device according to one embodiment of the present invention. In this embodiment, a least five LED modular chips each having LEDs connected in same polar direction are arranged on a package substrate 36 to form a bridge-type circuit structure. A fifth LED modular chip 305 and a sixth LED modular chip 306 are forward connected. A seventh LED modular chip 307 and an eighth LED modular chip 308 are forward connected. The fifth LED modular chip 305 and the seventh LED modular chip 307 are reversely connected. The sixth LED modular chip 306 and the eighth LED modular chip 308 are reversely connected. A common LED modular chip 309 is forward connected with the fifth, sixth, seventh and eighth LED modular chips 305, 306, 307 and 308. Thus is formed a bridge-type AC LED package device 42. The two ends of the overall bridge-type AC LED package device 42 are respectively connected with two terminals of an AC power source 40. The forward-biased voltage drives the LED modular chips 305, 309 and 308 to emit light. The reverse-biased voltage drives the LED modular chips 307, 309 and 306 to emit light. The common LED modular chip 309 emits light persistently because it is the common path of the forward current the reverse current.

Therefore, the method of the present invention uses less-complicated photomasks. Accordingly, the present invention can effectively simplify the fabrication process, promote the yield and reduce the cost.

The embodiments described above are only to demonstrate the technical thought and characteristics of the present invention to enable the persons skilled in the art to understand, make, and use the present invention. However, it is not intended to limit the scope of the present invention. Any equivalent modification or variation according to the spirit of the present invention is to be also included within the scope of the present invention.

What is claimed is:

1. A method for fabricating an alternating-current light-emitting-diode package device, comprising steps:
providing a plurality of light emitting diode (LED) modular chips, wherein each of said LED modular chip has a plurality of LEDs in same polar direction connecting in series;
connecting forward and reversely said LED modular chips with a wire-bonding method to form an alternating-current light-emitting-diode package device; and
connecting said alternating-current light-emitting-diode package device with an alternating-current power source.

2. The method for fabricating an alternating-current light-emitting-diode package device according to claim 1, wherein said LED modular chips are fabricated on a visible light LED substrate or an invisible light LED substrate, which is made of a material selected from gallium arsenide, silicon nitride, aluminum oxide, germanium, gallium phosphide, silicon, glass, or sapphire.

3. The method for fabricating an alternating-current light-emitting-diode package device according to claim 1, wherein each said LED modular chip contains said LEDs with same polar direction connecting in series.

4. The method for fabricating an alternating-current light-emitting-diode package device according to claim 1, wherein each said LED modular chip contains said LEDs connected in series and parallel in same polar direction.

5. The method for fabricating an alternating-current light-emitting-diode package device according to claim 1, wherein said LED modular chips are arranged in a parallel or in an array to form said alternating-current light-emitting-diode package device.

6. The method for fabricating an alternating-current light-emitting-diode package device according to claim 1, wherein said LED modular chips are arranged in a bridged-type arrangement to form said alternating-current light-emitting-diode package device.

7. The method for fabricating an alternating-current light-emitting-diode package device according to claim 6, wherein said alternating-current light-emitting-diode package device contains at least five said LED modular chips.

8. The method for fabricating an alternating-current light-emitting-diode package device according to claim 1, wherein said LED modular chips are connected forward and reversely and then connected in parallel, in series or in parallel and series.
